(19) United States
(12) Patent Application Publication
(10) Pub. No.: US 2016/0113407 A1
(43) Pub. Date: Apr. 28, 2016

(54) Travel Headrest Device with Flexible Tethers, Detachable Multi-Axis Joints and Permanent Swivel Mounting Option

(71) Applicant: Daniel Sampson, Surrey (CA)

(72) Inventor: Daniel Sampson, Surrey (CA)

(21) Appl. No.: 14/920,492

(22) Filed: Oct. 22, 2015

Related U.S. Application Data
(60) Provisional application No. 62/067,137, filed on Oct. 22, 2014.

(51) Int. Cl. A47C 16/00; A47C 7/38; F16M 11/20

(52) U.S. Cl. CPC A47C 16/00; F16M 11/2057; A47C 7/383

(57) ABSTRACT

A portable headrest device suitable for use in travel situations features an elongated main support, a headrest for carrying on the elongated main support in an elevated position above a support surface, a base plate for placement on the support surface to stabilize the elongated main support in the upright operational position, and a respective multi-axis joint between the elongated main support and each of the headrest and the base plate. At each joint, a shaft end, for example a respective end of the main support, is received and frictionally held within a flexible bushing surrounded by a rigid housing, whereby tilting of the shaft end in multiple directions is allowed. The bushing provides resistance against the tilting to prevent excess looseness or wobbling, and also a degree of shock and vibration absorption. The frictional coupling between the shaft and bushing holds the joint together without need for separate fasteners.

### CROSS REFERENCE TO RELATED APPLICATIONS

This application claims benefit under 35 U.S.C. 119(e) of Provisional Application Ser. No. 62/067,137, filed Oct. 22, 2014.

### FIELD OF THE INVENTION

The present invention relates generally to an auxiliary headrest device suitable for traveler use in airplanes, trains, automobiles and the like, and more particularly to a travel headrest with improved position retention means, improved adjustability and unique mounting means for permanent installations.

### BACKGROUND OF THE INVENTION

It is known in the prior art to provide an auxiliary headrest that is usable by travellers on airplanes, trains, buses, or other long-distance means of passenger conveyance. Examples are seen in U.S. Pat. Nos. 245,639 and 7,748,064, each of which feature a main upright support pole that carries a padded headrest at the top end thereof, and an extra arm support at an intermediate position further down the pole.

Other portable headrest designs include those disclosed in U.S. Patent Application Publication Nos. 2013/0232696, 2014/0312186 and 2015/0001905.

However, there remains room for improvement, and applicant has developed a unique travel headrest product that adds a number of unique and advantageous features not found in these prior solutions.

### SUMMARY OF THE INVENTION

According to a first aspect of the invention, there is provided a headrest device comprising:

an elongated main support;

a headrest mounted or mountable on said elongated main support for carrying of said headrest on the elongated main support in an elevated when said elongated main support is placed in an upright operational position; and

a pair of flexible tethers each having a proximal end connected or connectable to said elongated main support and an opposing distal end that is freely movable relative to the proximal end of the tether and the elongated main support, whereby the distal ends of the pair of flexible tethers are available for connection to one another or to one or more other objects in order to help maintain the elongated main support in the upright operational position.

Each flexible tether may comprise a respective coupling member at the distal end thereof for detachable connection of the flexible tethers to one another, or to said one or more other objects, via said coupling members.

Each coupling member may be a carabiner.

Each flexible tether may be adjustable in length.

Each flexible tether may be separate from the other flexible tether, and the flexible tethers may each be anchored to a respective end of a cross-pin that passes through the elongated main support.

Preferably the headrest and the elongated main support are coupled by way of a multi-axis joint by which the headrest and the elongated main support can pivot relative to one another about two-axes.

Preferably the multi-axis headrest joint comprise a flexible headrest bushing.

Preferably the flexible headrest bushing is circumscribed by a headrest mounting bracket attached to one of either the elongated main support or the headrest, and a headrest shaft-end on the other of either the elongated main support or the headrest is inserted into the flexible headrest bushing and restrained to a limited range of tilt by the headrest mounting bracket.

Preferably the headrest mounting bracket is attached to the headrest, and the elongated main support comprises a shaft defining the headrest shaft end that is received in the flexible headrest bushing.

Preferably the headrest shaft-end is arranged to frictionally engage with the flexible headrest bushing in a releasable and re-attachable manner to enable disassembly and re-assembly of the elongated main support and the headrest.

Preferably there is provided a base plate attached or attachable to the elongated main support at an end thereof located distal to the headrest.

Preferably the base plate and the elongated main support are coupled by way of a multi-axis base plate joint by which the base plate and the elongated main support can pivot relative to one another about two-axes.

Preferably the multi-axis base plate joint comprise a flexible base plate bushing.

Preferably the flexible base plate bushing is circumscribed by a base plate mounting bracket attached to one of either the elongated main support or the base plate, and a base plate shaft-end on the other of either the elongated main support or the base plate is inserted into the flexible base plate bushing and restrained to a limited range of tilt by the base plate mounting bracket.

Preferably the base plate mounting bracket is attached to the base plate, and the elongated main support comprises a shaft defining the base plate shaft-end that is received in the flexible base plate bushing.

Preferably the base plate shaft-end is arranged to frictionally engage with the flexible base plate bushing in a releasable and re-attachable manner to enable disassembly and re-assembly of the elongated main support and the base plate.

There may be provided a support bracket for mounting to a seat or nearby object or structure, the support bracket having a fastening portion arranged for fastening to the seat or nearby object or structure, and a swivelling portion that is arranged for swivelling movement relative to the fastening portion and arranged for connection to the elongated main support at an end thereof distal to the headrest, whereby the support bracket carries a lower end of the elongated main support in the upright operational position.

According to a second aspect of the invention, there is provided a headrest device comprising:

an elongated main support;

a headrest for carrying on the elongated main support in an elevated position when said elongated main support is placed in an upright operational position; and

a multi-axis joint by which the headrest and the elongated main support are connected or connectable to carry said headrest on the elongated main support;

wherein the multi-axis headrest joint allows relative pivoting between the headrest and the elongated main support about two-axes.

According to a third aspect of the invention, there is provided a headrest device comprising:

an elongated main support;

a headrest for carrying on the elongated main support in an elevated position above a support surface when said elongated main support is placed in an upright operational position standing upwardly away from said support surface;

a base plate for placement on the support surface to stabilize the elongated main support in the upright operational position;

a multi-axis joint by which the base plate and the elongated main support are connected or connectable to carry said main elongated support on the base plate;

wherein the multi-axis joint allows relative pivoting between the base plate and the elongated main support about two-axes.

According to a fourth aspect of the invention, there is provided a headrest device comprising:

an elongated main support;

a headrest mounted or mountable on said elongated main support for carrying of said headrest on the elongated main support in an elevated position when said elongated main support is placed in an upright operational position and

a support bracket mounted or mountable to a seat or nearby object or structure, the support bracket having a fastening portion arranged for fastening to the seat or nearby object or structure, and a swivelling portion that is arranged for swivelling movement relative to the fastening portion and arranged for connection to the elongated main support at an end thereof distal to the headrest, whereby the support bracket is arranged to carry a lower end of the elongated main support in the upright operational position.

According to a fifth aspect of the invention, there is provided a headrest device comprising:

an elongated main support;

a headrest for carrying on the elongated main support in an elevated position when said elongated main support is placed in an upright operational position;

a multi-axis headrest joint by which the headrest and the elongated main support are connected or connectable to carry said headrest on the elongated main support;

a base plate for placement on the support surface to stabilize the elongated main support in the upright operational position; and

a multi-axis base plate joint by which the base plate and the elongated main support are connected or connectable to carry said main elongated support on the base plate

wherein the multi-axis headrest joint allows relative multi-directional pivoting between the headrest and the elongated main support and the multi-axis joint allows relative multi-directional pivoting between the base plate and the elongated main support.

### BRIEF DESCRIPTION OF THE DRAWINGS

Preferred embodiments of the invention will now be described in conjunction with the accompanying drawings in which:

FIG. 1 is a front elevational view of a portable headrest device according to one embodiment of the present invention.

FIG. 2 is a side elevational view of the portable headrest device of FIG. 1.

FIG. 3 is a side elevational view of the portable headrest device during use by an airline, bus or rail passenger.

FIG. 4 is a partial cross-sectional view of the portable headrest device showing a flexible, multi-axis, detachable pivot joint between a main upright pole and headrest plate of the device.

FIG. 4A is an exploded view of the headrest pivot joint of FIG. 4.

FIG. 5 is a bottom plan view showing installation of the headrest pivot joint of FIG. 4 on the underside of the headrest plate.

FIG. 6 is a partial cross-sectional view of the portable headrest device showing another flexible, multi-axis, detachable pivot joint thereof, this one being defined between the main upright pole and a stabilization base plate at the bottom end thereof.

FIG. 7 is a side elevational view illustrating installation of a fixed or permanent support bracket mounted to the front edge of a passenger seat of an aircraft, bus, train or the like to carry the main pole of the headrest device in an upright position at the front of the seat during use.

FIG. 8 is a side elevational view of the fixed support bracket of FIG. 7 during lowering of the headrest device into a stowed, out of the way position when the headrest is not in use.

FIG. 9 is a top view of the fixed support bracket of FIG. 8.

FIG. 10 is a front view of the fixed support bracket of FIG. 9.

### DETAILED DESCRIPTION

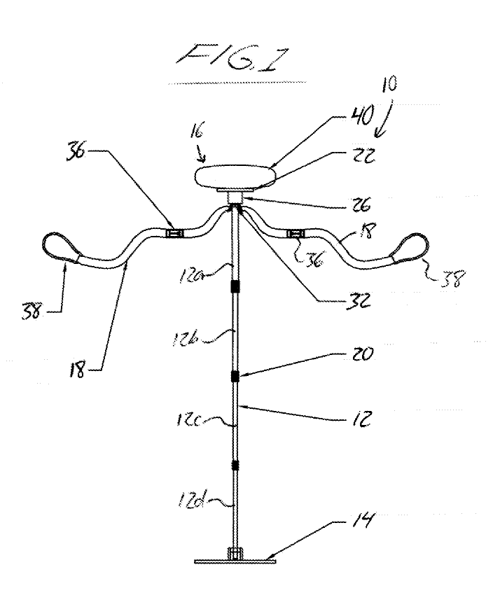

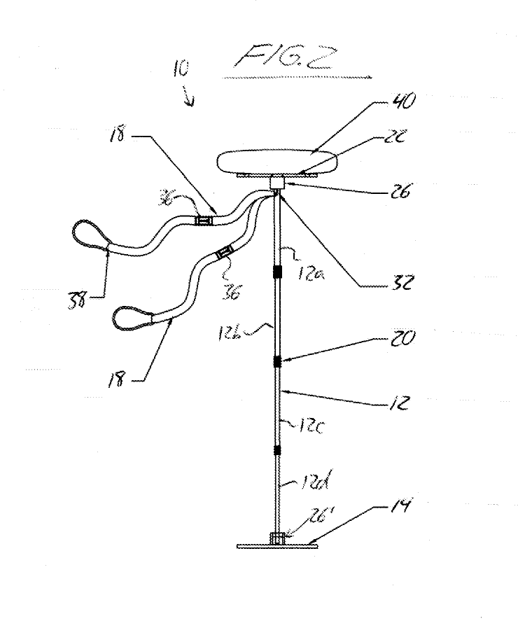

FIGS. 1 to 3 show a portable headrest device 10 of the present invention, which includes a telescopic main support pole 12, a base stabilization plate 14 mounted to the bottom end of the pole 12, a headrest 16 mounted at the opposing top end of the pole 12, and a pair of flexible tether straps 18 attached to the pole 12 near the upper end thereof. The pole 12 is made up of a series of telescopically mated hollow shafts 12a, 12b, 12c, 12d that can be axially collapsed into a compact configuration substantially nested within one another, and extended out of this collapsed state to achieve a maximum attainable length of the overall pole structure 12, or any number of possible intermediate lengths between the minimum and maximum attainable pole lengths. Twist-type telescopic clamps 20 may be used for the purpose of defining respective locking mechanisms between the adjacent pairs of shaft sections to allow locking thereof at any selected amount of telescopic extension/retraction therebetween. The headrest features a headrest plate 22 atop which a pillow or cushion 24 is placed or held.

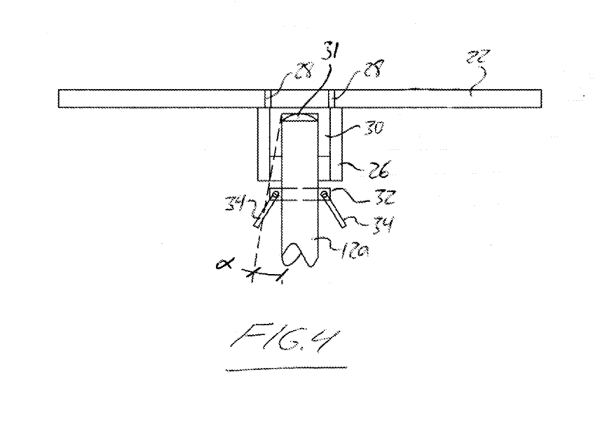

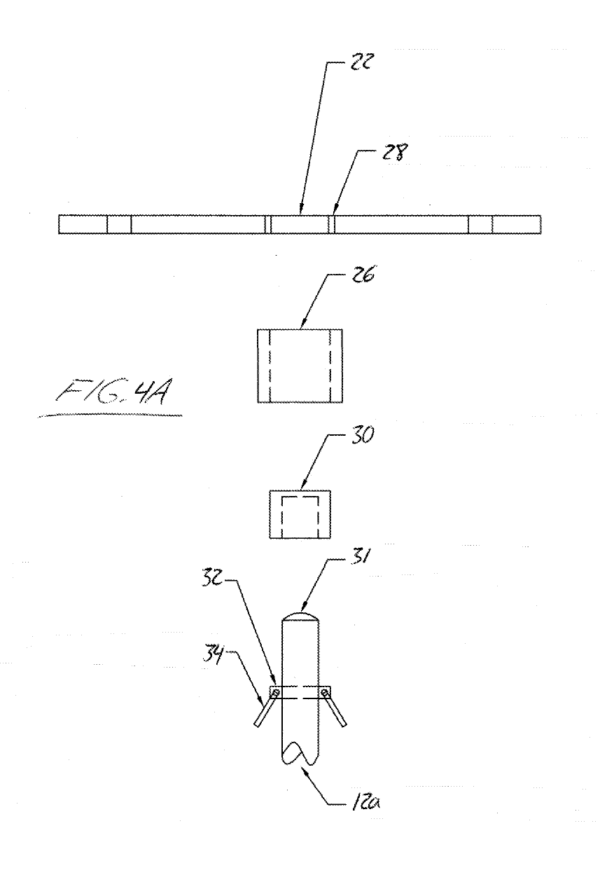

FIG. 4 illustrates how the top headrest plate 22 is mounted atop the pole 12. A headrest mounting bracket 26 is provided in the form of a rectangular block having a central cylindrical bore passing axially through it. One of its two bored-through ends is placed flat against an underside of the headrest plate 22, and is fastened thereto through suitable fastener holes 28 in the headrest plate 22. A flexible cylindrical bushing 30 of rubber or other resilient material is fitted into the cylindrical bore of the headrest mounting bracket 26 through the open end thereof lying opposite to the headrest plate 22 that now covers off the opposing end of the mounting bracket's through-bore. One end of the bushing 30 is abutted up against the headrest plate 22, and the axial length of the bushing 30 is less than that of the mounting bracket's through-bore, whereby the other end of the bushing 30 stops short of the lower end of the mounting bracket that is situated furthest from the headrest plate 22. The top end of the pole 12, as defined by the top end of the uppermost shaft section 12a, may feature an end cap 31 of spherically convex contour, and is inserted into the open lower end of the bushing 30 through the open lower end of the bracket 26.

As a result of the resiliency of the rubber bushing 30 and the empty lower portion of the mounting bracket bore that is left unoccupied by the bushing 30 to provide clearance between the upper shaft section 12a and the inner wall of the mounting bracket, the pole 12 is allowed to tilt relative to the longitudinal axis of the mounting bracket in any radial direction therefrom. In other words, even while frictionally retained in the bushing in the axial direction, the pole 12 is free to pivot about two perpendicular axes, each lying normal to that the of the mounting bracket bore. The bushing provides resistance to this relative titling between the pole and headrest so that it doesn't feel too loose or wobbly, and the resilience of the rubber bushing also provides some shock absorption during use of the headrest. Under sufficient tilting out of the default concentric position into which the pole is biased by the resilient bushing, the pole will eventually come into contact with the peripheral wall of the mounting bracket's bore, which thus limits the attainable angular range of tilt a in any direction to a predetermined amount, which may for example be in order of 10-degrees to 15-degrees in some embodiments.

With continued reference to FIG. 4, a cross-pin 32 passes diametrically through the uppermost shaft section 12a at a short height below the open bottom end of the headrest mounting bracket 26. A respective cross-bore passing diametrically through the pin 32 near each end thereof outside the uppermost shaft section 12a of the pole 12 has a respective rigid loop or ring 34 passing therethrough, for example in the form of a steel D-ring or the like. Each of the two flexible tether straps is anchored to one of these loops or rings 34, for example being sewn into a permanent loop therethrough, in order to securely attach the tether strap to the pole 12. Each tether strap is length adjustable, for example by way of suitable adjustment clip or buckle 36 at an intermediate point between the proximal end of the strap that is secured to the pole 12 by one of the anchoring loops 34, and the opposing distal end of the strap that is freely movable relative to the pole due to the strap's flexible nature. Each strap carries a respective carabiner 38 or other openable and closeable coupling member at its distal end, by which the two tether straps can be releasably coupled to one another, or to other objects, in order to help stabilize the headrest device during use. It will be appreciated that the two tethers may be attached to the pole by means other than the described cross-pin and anchoring loops.

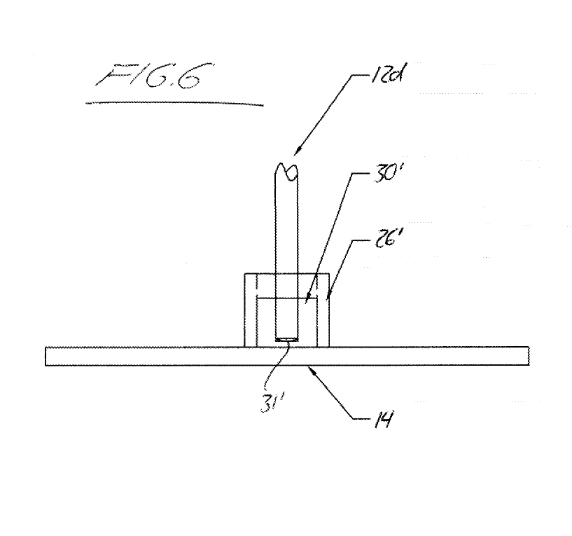

With reference to FIG. 6, the base plate 14 is mounted to the bottom of the pole 12 in much the same way that the headrest plate is mounted to the top of the pole 12. A base plate mounting bracket 26′ is provided in the form of a rectangular block having a central cylindrical bore passing axially through it. One of its two bored-through ends is placed flat against a topside of the base plate, and is fastened thereto through suitable fastener holes in the base plate. A flexible cylindrical bushing 30′ of rubber or other resilient material is fitted into the cylindrical bore of the base plate mounting bracket through the open end thereof lying opposite to the base plate that now covers off the opposing end of the mounting bracket's through-bore. One end of the bushing 30′ is pushed down against the base plate, and the axial length of the bushing 30′ is less than that of the mounting bracket's through-bore, whereby the other end of the bushing 30′ stops short of the upper end of the mounting bracket that is situated furthest from the base plate. The bottom end of the pole 12, as defined by the bottom end of the lowermost shaft section 12d, is inserted into the open upper end of the bushing 30 through the open upper end of the base plate bracket. The bottom end of the pole may feature a rounded end cap 31′ like that found at the top end of the pole.

As a result of the resiliency of the rubber bushing 30′ and the empty upper portion of the mounting bracket bore that is left unoccupied by the bushing 30′ to provide clearance between the lower shaft section 12d and the inner wall of the mounting bracket 26′, the pole 12 is allowed to tilt relative to the longitudinal axis of the base plate mounting bracket in any radial direction therefrom. In other words, even while frictionally retained in the bushing in the axial direction, the pole 12 is free to pivot about two perpendicular axes, each lying normal to that the of the base plate mounting bracket 26′. The bushing provides resistance to this relative titling between the pole and base plate 14 so that the pole doesn't feel too loose or wobbly, and the resilience of the rubber bushing also contributes to the aforementioned shock absorption during use of the headrest. As described above for the headrest, under sufficient tilting out of the default concentric position into which the pole is biased by the resilient bushing, the pole will eventually come into contact with the peripheral wall of the mounting bracket's bore, which thus limits the attainable angular range of tilt in any direction to a predetermined amount. As for the headrest, the base plate's tilt limit relative to the pole 12 may be in order of 10-degrees to 15-degrees in some embodiments.

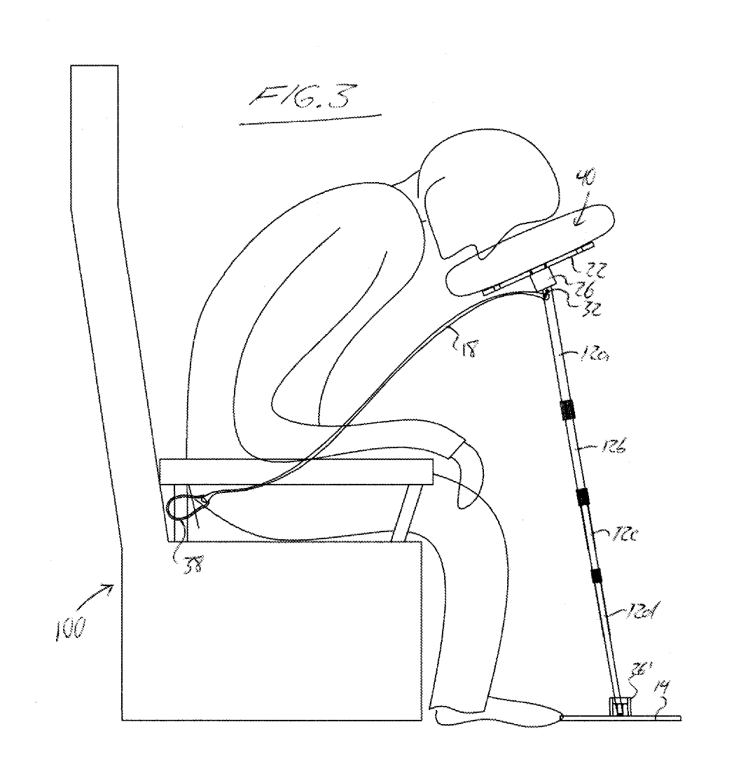

With reference to FIG. 3, the user operates the product by placing the base plate on the ground in front of the chair or seat 100 in which the user is seated, and with the telescopic pole adjusted to a suitable height, the user rests his or her head on the product's top-plate, which holds a soft compact pillow 40. The above described mounting bracket with the flexible rubber bushing inside allows the top-plate and pillow assembly to easily attach to and detach from the adjustable telescoping pole. The friction fit between the bushing and the pole provides enough holding force to prevent the headrest from falling free of the pole, but can be manually overcome with a reasonable pulling force in order to separate the headrest from the pole for compact disassembly. The same flexible joint between the base plate and the pole allows the base plate to also be detached, which together with the axially collapsible nature of the telescopic pole, further reduces the footprint of the device for compact storage and conveyance. The frictional coupling of the pole with each bushing avoids the need for any additional fastening components beyond the bushing and pole themselves, thereby simplifying the apparatus and its operation, and prevent potential loss of detachable fastening components.

When the headrest is in use, the rubber bushing allows the top-plate assembly to tilt slightly in all directions, but with a limited range, which again may be in the order of approximately 10 to 15 degrees, depending on the flexibility of the rubber bushing used and the selected clearance measurement between the centered position of the pole and the surrounding confines of the bracket. The tilting feature of the top-plate assembly allows the user to suit the angle of top-plate and pillow to the user's head height and body position. The easy-to-deploy telescoping support pole is height adjustable, allowing the user to find a precise height for the top-plate assembly, which best fits their particular body type and preference.

In one embodiment, ABS plastic is employed for the headrest plate, headrest mounting bracket, stabilizing base plate, base plate mounting bracket, and the pole is formed of lightweight aluminum pipe or tubing. The hard ABS top-plate ensures that there is enough resistance beneath the pillow for the user to find comfortable angles to position their head while resting on the device. The tethering straps may be made of nylon webbing or other flexible strap material, and aluminum carabiners may be employed to provide strong, but lightweight coupling members.

The tethering straps are used for added support and stability. The flexible tethered connection allows the device to be secured in many fashions. For example, the support straps can be secured together around the user's back, like a harness; clipped to pant pockets or belt loops of clothing worn by the user; fastened to the arms or bases of seats; fastened to seat-belts; or fastened to any structure which is rigidly secured in place in the passenger cabin of the vehicle concerned.

The forgoing device has been designed to support the head and upper body in a variety of situations, though its primary intended use is to assist with resting and sleeping while traveling on planes, trains, buses, and cars while seated. It has been designed to be light-weight, compact, and stable in operation; to occupy minimal space when deployed and be easily set up and subsequently packed away after use. Combined, these features make the device an ideal sleep-aid product for frequent travelers.

Particularly unique and advantageous features of the forgoing embodiments of the invention described above are briefly summarized as follows:

### 1. Stability Straps

The stability straps provide additional and improved device stability, and are particularly useful when deployed in environments where the user may encounter turbulence or unexpected jarring movement. Some common examples might be when travelling on trains, airplanes, or cars, though this list is certainly not exhaustive.

The straps allow for the weight of the device to be counterbalanced by the user's upper torso weight, when the user is leaning forward with their head pushed against the top-plate assembly.

The straps prevent the device from falling over or slipping out from beneath the user when they are asleep, where self-movement is most likely to occur.

### 2. Compact, Light-Weight, and Travel-Friendly

Device is constructed from durable, light-weight materials.

Adjustable telescoping pole allows the device to compact in size.

Device is easy to assemble and disassemble in confined spaces, and once assembled can easily be moved about, which minimizes disturbance to neighboring passengers and allows passage in confined spaces.

Top-plate assembly can be quickly and easily removed from the pole.

Compact pillow does not require a large volume of valuable luggage space.

Device and all components attach and detach easily.

Device can be packed away neatly into a compact travel case.

### 3. Stabilizing Base Plate

The lower base plate receives the end of the telescoping pole, and provides additional stability.

### 4. Flexible Rubber Bushing

The rubber bushing which is found in both the upper and lower mounting brackets, not only provides flexibility, but also provides some shock-absorbing capacity. This would help to reduce vibrations at the top-plate assembly.

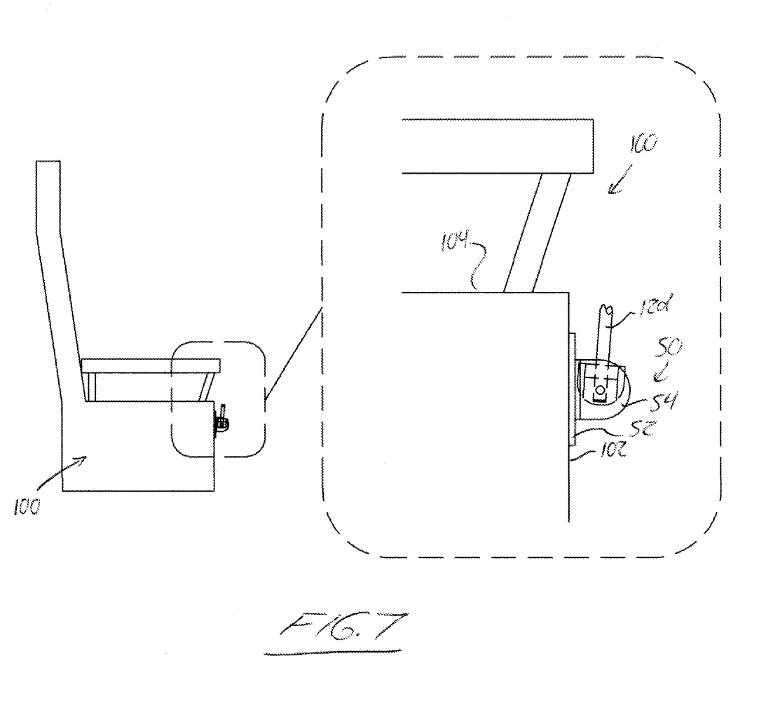

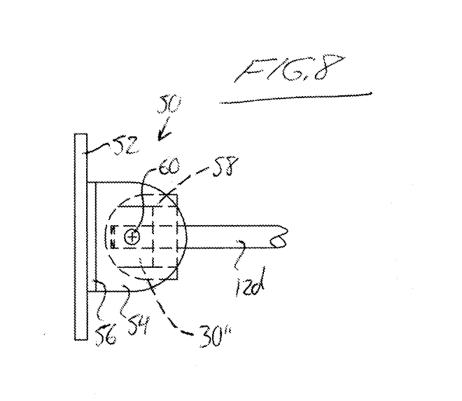

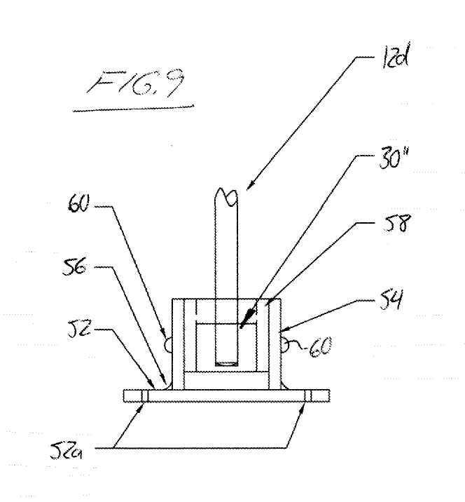

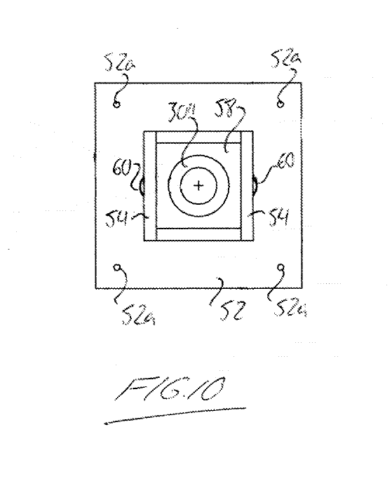

Turning to FIG. 7, a fixed support bracket 50 may be removable or permanently mounted to a seat 100 or nearby object in the passenger cabin of an aircraft, bus, train, automobile etc. and used in place of the floor-seated base plate 14 of the first embodiment in order to support the headrest device in an upright position in front of the seat. The illustrated example shows the fixed bracket 50 as being mounted to the seat 100 itself at a midway point across the front edge 102 of the seat frame at an elevated position spaced up from the floor and residing just below the seating surface 104 of the seat 100. The lower end of the pole 12 of the headrest device 10, the rest of which has been omitted from FIGS. 7 to 10 for ease of illustration, is supported by the fixed bracket 50, and can be swivelled into and out of its useful position standing upright at the front of the seat, for example folded downwardly out of this position, where it can then be stowed for periods of time when the headrest is not needed. The headrest device can thus be swung out of the way during boarding de-boarding in order to allow comfortable easy access to the seat, and can be kept in such a stowed position until such a time when the passenger wishes to use the headrest.

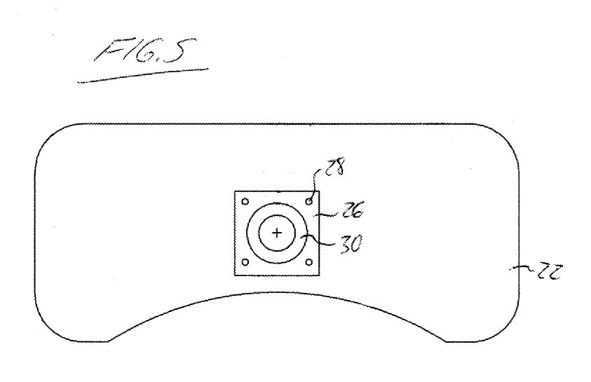

The fixed bracket 50 features a flat mounting plate 52 with fastener holes 52a by which it can be fastened to the front edge of the seat frame or to another suitable support structure or object in the passenger cabin of the vehicle concerned. A pair of lugs 54 project perpendicularly from the mounting plate 52 in parallel vertical planes at horizontally spaced positions from one another. The mounting plate and lugs may be welded together, as shown at 56, and in one example, may be formed of stainless steel to provide suitable strength and resistance to corrosion, but it will be appreciated that other materials may alternatively be employed. A swivelling block 58 is pivotally suspended between the pair of lugs 54 by a pair of aligned pivot pins 60 each passing through a respective one of lugs to pivotally connect a respective side of the block 58 thereto, whereby the block 58 suspended between the two lugs can swivel about a horizontal axis shared by these pivot pins 60. The swivel block 58 has cylindrical bore therein, which, like that of the headrest mounting bracket 26, contains a cylindrical rubber bushing 30″ that resides at one end of the bore and occupies less than a full axial length thereof. The swivel block may be identical to either of the mounting blocks 26, 26′ described above for the embodiment of FIGS. 1 to 6. The capped lower end of the lowermost shaft section 12d of the main support pole 12 of the headrest device is received in the bushing 30″ through the end of the bore that is unoccupied by the bushing. Accordingly, the support pole 12 of the headrest device 10 can tilt in any direction within the swivel block 58 of the fixed mounting bracket 50, just as it could in the base plate mounting bracket 26′ of the embodiment shown in FIGS. 1 to 6.

Referring to FIG. 7, with the mounting plate 52 of the fixed bracket 50 mounted flush against the front edge of the seat in an upright plane with the two lugs 54 lying in respective vertical planes on opposing sides of a vertical mid-plane of the seat, the swivel block 58 carries the support pole 12 of the headrest device in a manner pivotal up and down in the central mid-plane of the seat into an operational position standing upright from the front edge of the seat to place the headrest at an elevation where the passenger can tilt or lean his/her head and/or torso forward in order to lay his/her head on the pillow or cushion 40 of the headrest device. When use of the headrest is not desired, the passenger can simply lower the headrest downward about the horizontal pivot axis of the fixed mounting bracket 50. The headrest may be laid upon the floor at a distance forwardly of the passenger seat 100, or if the pole 12 is telescopically collapsible to a sufficient degree, the headrest may be swung back under the passenger seat 100 for convenient storage in a manner that minimizes obstruction to the passenger's available foot room in front of the seat.

It will be appreciated that select features of the inventive headrest may employed in combination with, or independently of, one another. For example, the use of flexible tethers to allow connection of the headrest device to any of a variety of other objects for stabilization purposes, regardless of the particular environment in which the headrest is used, can be employed regardless of whether the same headrest device also employs the described multi-axis joint between the support pole and the headrest and/or base plate. Likewise, the swivelling bracket for fixed or permanent mounting solutions may be employed regardless of whether the connected headrest device features flexible tethers and/or multi-axis joints. The same headrest device may be used either with a removable base plate or a permanently mounted swivel bracket simply by inserting the bottom end of the pole into a selected one of either a compatible base plate or swivel bracket in cases where a simple friction fit connection allows such simple connection and detachment.

In embodiments that include a base plate, it may be circular, or any one of a number of possible other shapes. Although nylon straps have been found to be suitable stabilization tethers, other materials and other shapes could also be used, such as flexible cords, ropes, strings, or cables. It will also be appreciated that while use of ABS or other plastic of suitable strength has been described for the headrest and base plates, and the mounting brackets of the associated joints, in order to minimize the weight of the device, metals or other materials may alternatively be employed.

Since various modifications can be made in my invention as herein above described, and many apparently widely different embodiments of same made within the scope of the claims without departure from such scope, it is intended that all matter contained in the accompanying specification shall be interpreted as illustrative only and not in a limiting sense.

1. A headrest device comprising:
an elongated main support;
a headrest for carrying on the elongated main support in an elevated position when said elongated main support is placed in an upright operational position; and
a multi-axis joint by which the headrest and the elongated main support are connected or connectable to carry said headrest on the elongated main support;
wherein the multi-axis joint allows relative pivoting between the headrest and the elongated main support about two-axes.

2. The headrest device of claim 1 wherein the multi-axis joint comprise a flexible bushing.

3. The headrest device of claim 2 wherein the flexible bushing is circumscribed by a mounting bracket attached to one of either the elongated main support or the headrest, and a shaft-end on the other of either the elongated main support or the headrest is inserted into the flexible bushing and restrained to a limited range of tilt by the mounting bracket.

4. The headrest device of claim 3 wherein the mounting bracket is attached to the headrest, and the elongated main support comprises a shaft defining the shaft end that is received in the flexible headrest bushing.

5. The headrest device of claim 3 wherein the shaft-end is arranged to frictionally engage with the flexible bushing in a releasable and re-attachable manner to enable disassembly and re-assembly of the elongated main support and the headrest.

6. A headrest device comprising:
an elongated main support;
a headrest for carrying on the elongated main support in an elevated position above a support surface when said elongated main support is placed in an upright operational position standing upwardly away from said support surface;
a base plate for placement on the support surface to stabilize the elongated main support in the upright operational position;
a multi-axis joint by which the base plate and the elongated main support are connected or connectable to carry said main elongated support on the base plate;
wherein the multi-axis joint allows relative pivoting between the base plate and the elongated main support about two-axes.

7. The headrest device of claim 6 wherein the multi-axis joint comprise a flexible bushing.

8. The headrest device of claim 7 wherein the flexible bushing is circumscribed by a mounting bracket attached to one of either the elongated main support or the base plate, and a shaft-end on the other of either the elongated main support or the base plate is inserted into the flexible bushing and restrained to a limited range of tilt by the mounting bracket.

9. The headrest device of claim 8 wherein the base plate mounting bracket is attached to the base plate, and the elongated main support comprises a shaft defining the shaft-end that is received in the flexible bushing.

10. The headrest device of claim 8 wherein the shaft-end is arranged to frictionally engage with the flexible bushing in a releasable and re-attachable manner to enable disassembly and re-assembly of the elongated main support and the base plate.

11. The headrest device of claim 1 comprising a support bracket for mounting to a seat or nearby object or structure, the support bracket having a fastening portion arranged for fastening to the seat or nearby object or structure, and a swivelling portion that is arranged for swivelling movement relative to the fastening portion and arranged for connection to the elongated main support at an end thereof distal to the headrest, whereby the support bracket carries a lower end of the elongated main support in the upright operational position.

12. A headrest device comprising:
an elongated main support;
a headrest for carrying on the elongated main support in an elevated position when said elongated main support is placed in an upright operational position;
a multi-axis headrest joint by which the headrest and the elongated main support are connected or connectable to carry said headrest on the elongated main support;
a base plate for placement on the support surface to stabilize the elongated main support in the upright operational position; and
a multi-axis base plate joint by which the base plate and the elongated main support are connected or connectable to carry said main elongated support on the base plate;
wherein the multi-axis headrest joint allows relative multi-directional pivoting between the headrest and the elongated main support and the multi-axis joint allows relative multi-directional pivoting between the base plate and the elongated main support.

13. The headrest device of claim 12 wherein the multi-axis headrest joint comprise a flexible headrest bushing.

14. The headrest device of claim 13 wherein each flexible headrest bushing is circumscribed by a headrest mounting bracket attached to one of either the elongated main support or the headrest, and a headrest shaft-end on the other of either the elongated main support or the headrest is inserted into the flexible headrest bushing and restrained to a limited range of tilt by the headrest mounting bracket.

15. The headrest device of claim 14 wherein the headrest mounting bracket is attached to the headrest, and the elongated main support comprises a shaft defining the headrest shaft end that is received in the flexible headrest bushing.

16. The headrest device of claim 14 wherein the headrest shaft-end is arranged to frictionally engage with the flexible headrest bushing in a releasable and re-attachable manner to enable disassembly and re-assembly of the elongated main support and the headrest.

17. The headrest device of claim 12 wherein the multi-axis base plate joint comprise a flexible base plate bushing.

18. The headrest device of claim 17 wherein the flexible base plate bushing is circumscribed by a base plate mounting bracket attached to one of either the elongated main support or the base plate, and a base plate shaft-end on the other of either the elongated main support or the base plate is inserted into the flexible base plate bushing and restrained to a limited range of tilt by the base plate mounting bracket.

19. The headrest device of claim 18 wherein the base plate mounting bracket is attached to the base plate, and the elongated main support comprises a shaft defining the base plate shaft-end that is received in the flexible base plate bushing.

20. The headrest device of claim 18 wherein the base plate shaft-end is arranged to frictionally engage with the flexible base plate bushing in a releasable and re-attachable manner to enable disassembly and re-assembly of the elongated main support and the base plate.
